(19) United States
(12) Patent Application Publication
(10) Pub. No.: US 2008/0228840 A1
(43) Pub. Date: Sep. 18, 2008

(54) DATA UPDATING METHOD AND DATA PROCESSING SYSTEM

(75) Inventor: Haruyasu HAYASAKA, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 12/047,176

(22) Filed: Mar. 12, 2008

(30) Foreign Application Priority Data
Mar. 13, 2007 (JP) 063235

(51) Int. Cl. G06F 17/30

(52) U.S. Cl. 707/203; 707/E17.001

(57) ABSTRACT

A data updating method includes the steps of updating data in a first information processing apparatus by the first information processing apparatus, acquiring apparatus information of a second information processing apparatus by the first information processing apparatus when the data is updated, comparing apparatus information of the first information processing apparatus with the acquired apparatus information of the second information processing apparatus by the first information processing apparatus, and transmitting the updated data to the second information apparatus by the first information processing apparatus on the basis of a comparison result. A data processing system is also disclosed.

This application is based upon and claims the benefit of priority from Japanese patent application No. 2007-063235, filed on Mar. 13, 2007, the disclosure of which is incorporated herein in its entirety by reference.

### BACKGROUND OF THE INVENTION

The present invention relates to a data updating method and a data processing system and, more particularly, to data updating in a data processing system comprising a plurality of information processing apparatuses.

In recent years, a system incorporating a large number of equivalent server apparatuses and exemplified by a blade system has been proposed. In such a system, each server apparatus comprises a memory which stores various kinds of data such as firmware (FW), database, and control programs. Since the respective server apparatuses which constitute the system have equivalent configurations, many data stored in the memories are also identical in all server apparatuses. To update the data in a given server apparatus included in the system, the data in other server apparatuses included in this system must often be updated. Conventionally, an operator manually updates each server apparatus, resulting in time-consuming and cumbersome operations until the data in all the server apparatuses are completely updated. A variety of S methods have been proposed to solve the above problem.

For example, Japanese Patent Laid-Open No. 2006-178751 discloses a technique for disclosing ROM data of a given apparatus to other apparatuses at the end of updating the data of the given apparatus and downloading ROM data to each of the other apparatuses when the version of the disclosed ROM data is higher than that of each of the other apparatuses.

In the above method, however, since the data receiving apparatus initiates downloading, a plurality of apparatuses may simultaneously download the ROM data. In this case, the sending apparatus is overloaded, resulting in downloading failures.

In the above method, whether the data is updated is determined in accordance with whether the version of the data currently stored in the memory is higher than that of the disclosed data. This allows only irreversible updating from a lower version to a higher version of data. An updating failure cannot restore the previous version.

### SUMMARY OF THE INVENTION

The present invention has been made in consideration of the above conventional problems and, has as its object to smoothly allow data updating.

According to an aspect of the present invention, there is provided a data updating method comprising the steps of updating data in a first information processing apparatus by the first information processing apparatus, acquiring apparatus information of a second information processing apparatus by the first information processing apparatus when the data is updated, comparing apparatus information of the first information processing apparatus with the acquired apparatus information of the second information processing apparatus by the first information processing apparatus, and transmitting the updated data to the second information apparatus by the first information processing apparatus on the basis of a comparison result.

According to another aspect of the present invention, there is provided a data processing system comprising a first information processing apparatus and a second information processing apparatus, the first information processing apparatus comprising a first data storage unit which stores data, an acquisition unit which acquires apparatus information of the second information processing apparatus when data stored in the data storage unit is updated, a comparison unit which compares apparatus information of the first information processing apparatus with the acquired apparatus information of the second information processing apparatus, and a transmission unit which transmits the updated data to the second information processing apparatus on the basis of a comparison result in the comparison unit.

### BRIEF DESCRIPTION OF THE DRAWINGS

FIG. 1 is a block diagram showing the arrangement of an updating system according to an embodiment of the present invention;

FIG. 2 is a flowchart showing the operation of the updating system shown in FIG. 1;

FIG. 3 is a block diagram showing the arrangement of an updating system according to a practical example of the present invention;

FIG. 4 is a flowchart showing the practical operation of the updating system shown in FIG. 3; and

FIG. 5 is an exemplary table showing the configuration of self apparatus information.

### DESCRIPTION OF THE PREFERRED EMBODIMENT

A preferred embodiment of the present invention will be described with reference to the accompanying drawings.

### [Data Processing System]

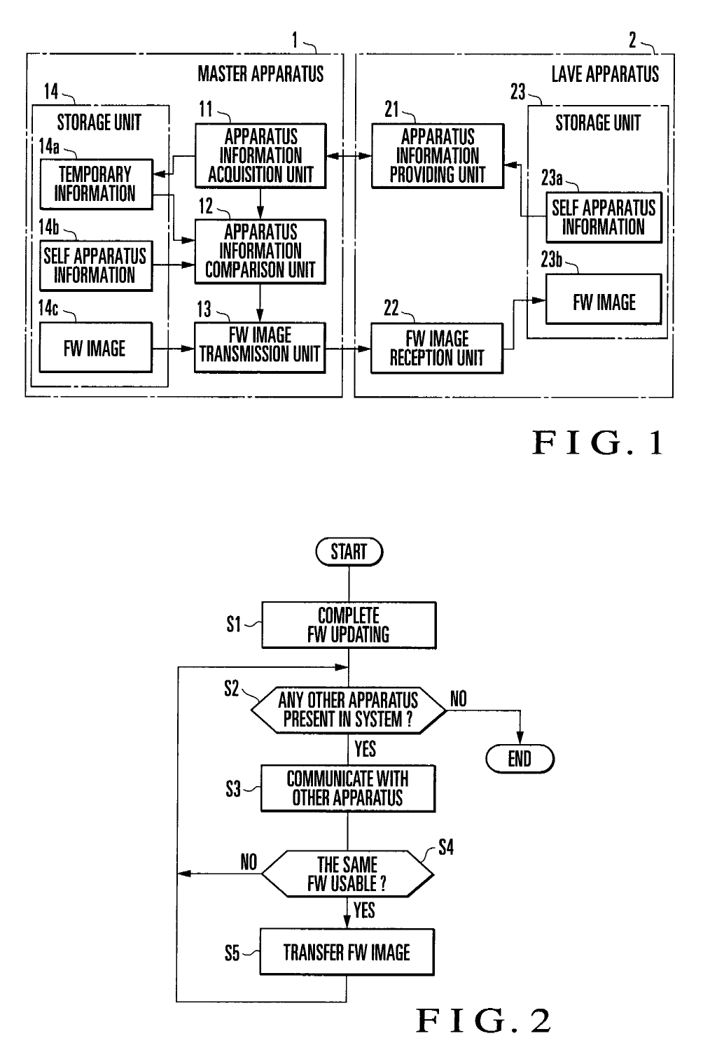

As shown in FIG. 1, a data processing system according to an embodiment is a system in which many information processing apparatuses such as servers are connected to each other. Among the information processing apparatuses, an information processing apparatus whose firmware (FW) has been updated serves as a master apparatus (first information processing apparatus), while remaining information processing apparatuses serve as slave apparatuses (second information processing apparatuses). For the descriptive convenience, this embodiment will exemplify a data processing system comprising one master apparatus 1 and one slave apparatus 2.

Each of the master apparatus 1 and the slave apparatus 2 comprises a computer and programs installed in this computer. The computer comprises an arithmetic unit such as a CPU, a storage unit such as a memory and an HDD (Hard Disk Drive), and an I/F unit which exchanges various kinds of information via a communication line. That is, the hardware apparatuses cooperates with software to make programs control the hardware resources, thereby implementing the respective functions of the master apparatus 1 and the slave apparatus 2. The above programs can be recorded on a computer-readable recording medium such as a flexible disk, CD-ROM, DVD-ROM, or memory card, or can be provided from an external apparatus via a communication line. The storage medium includes a nonvolatile memory which stores an FW image.

### <Master Apparatus>

The master apparatus 1 comprises at least an apparatus information acquisition unit 11, an apparatus information comparison unit 12, an FW image transmission unit 13, and a storage unit 14.

The apparatus information acquisition unit 11 acquires self apparatus information 23a of the slave apparatus 2 from the slave apparatus 2. The acquired self apparatus information 23a of the slave apparatus 2 is stored in the storage unit 14 as temporary information 14a.

The apparatus information comparison unit 12 compares the self apparatus information 23a of the slave apparatus 2 stored in the storage unit 14 as the temporary information 14a with self apparatus information 14b (to be described later) stored in the storage unit 14 to determine whether the FW updated in the master apparatus 1 can be applied to the slave apparatus 2. This determination result is output to the FW image transmission unit 13.

The FW image transmission unit 13 transmits an FW image 14c stored in the storage unit 14 to the slave apparatus 2 in accordance with the determination result in the apparatus information comparison unit 12.

The storage unit 14 stores at least the temporary information 14a, the self apparatus information 14b, and the FW image 14c. The temporary information 14a is information acquired by the apparatus information acquisition unit 11, i.e., the self apparatus information 23a of the slave apparatus 2. The temporary information 14a contains, e.g., the manufacturer, product name, and manufacturing number of the master apparatus. The FW image 14c is an image of an FW updated in the master apparatus 1. This FW controls the operation of the master apparatus 1.

### <Slave Apparatus>

The slave apparatus 2 comprises at least an apparatus information providing unit 21, an FW image reception unit 22, and a storage unit 23.

In response to a request from the master apparatus 1, the apparatus information providing unit 21 transmits the self apparatus information 23a (to be described later in detail) stored in the storage unit 23 to the master apparatus 1.

The FW image reception unit 22 receives the FW image from the master apparatus 1 and stores it in the storage unit 23 as an FW image 23b.

The storage unit 23 stores at least the self apparatus information 23a and the FW image 23b. The self apparatus information 23a represents the attributes of the slave apparatus 2. For example, the self apparatus information 23a contains the manufacturer, product name, and manufacturing number of the slave apparatus 2. The FW image 23b is an image of an FW updated by the master apparatus 1 and is transmitted as the FW 14c from the master apparatus 1. The FW controls the operation of the slave apparatus 2.

### [Operation of Data Processing System]

The operation of the data processing apparatus of this embodiment will be described with reference to FIG. 2.

When the master apparatus 1 completely updates the FW (step S1), the apparatus information acquisition unit 11 of the master apparatus 1 checks if an apparatus other than the master apparatus 1 is present in the data processing system (step S2). Note that the FW operation may be checked upon updating the FW in the master apparatus 1. This makes it possible to expect normal operation of the FW transmitted to the slave apparatus 2 in the following operation.

When an apparatus other than the master apparatus 1 is not present in the data processing system (NO in step S2), the master 1 completes its operation.

On the other hand, if an apparatus other than the master apparatus 1 is present in the data processing system (YES in step S2), the apparatus information acquisition unit 11 communicates with the apparatus present in the system and acquires the information of this apparatus (step S3). More specifically, the apparatus information acquisition unit 11 requests the slave apparatus 2 to transmit the self apparatus information 23a to the master apparatus 1. In response to this request, the apparatus information providing unit 21 of the slave apparatus 2 transmits the self apparatus information 23a stored in the storage unit 23 to the master apparatus 1. Upon reception of the self apparatus information 23a from the slave apparatus 2, the apparatus information acquisition unit 11 of the master apparatus 1 stores it as the temporary information 14a in the storage unit 14.

Upon reception of the self apparatus information 23a from the slave apparatus 2, the apparatus information comparison unit 12 of the master apparatus 1 determines whether the FW updated in the master apparatus 1 can be used in the slave apparatus 2 (step S4). More specifically, the apparatus information comparison unit 12 compares the self apparatus information 23a of the slave apparatus 2 stored as the temporary information 14a in the storage unit 14 with the self apparatus information 14b stored in the storage unit 14 to determine whether they match each other.

If the self apparatus information 14b does not match the self apparatus information 23a, the apparatus information comparison unit 12 determines that the FW updated in the master apparatus 1 cannot be used in the slave apparatus 2 (NO in step S4). The process then returns to the process in step S2.

On the other hand, when the self apparatus information 14a matches the self apparatus information 23a, the apparatus information comparison unit 12 determines that the FW updated in the master apparatus 1 can be used in the slave apparatus 2 (YES in step S4). The FW image transmission unit 13 transmits the FW image 14c stored in the storage unit 14 to the slave apparatus 2. Upon reception of the FW image 14c, the FW image reception apparatus 22 of the slave apparatus 2 stores it as the FW image 23b in the storage unit 23. Upon reception of the FW image 14c as described above, the slave apparatus 2 perform, e.g., rebooting to update the FW image 23b stored in the storage unit 23.

As described above, according to this embodiment, when the FW is updated in the master apparatus 1, the image of the updated FW is transmitted to the slave apparatus 2. This makes it possible to eliminate manual updating operation, thus facilitating the updating operation.

Since the FW image is transmitted from the master apparatus 1 to the slave apparatus 2, the master apparatus 1 can control the FW transmission timing and destination. This makes it possible to reduce the calculation load on the master apparatus 1 and smoothly transmit the FW.

Since the FW is transmitted based on the result of comparison between the self apparatus information 14b in the master apparatus 1 and the self apparatus information 23a in the slave apparatus 2, it can be determined whether the FW updated in the master apparatus 1 can be applied to the slave apparatus 2. This makes it possible to prevent a case in which the downloaded FW cannot be updated in the slave apparatus 1. Therefore, the slave apparatus 2 can smoothly update the FW.

Since the FW which is updated in the master apparatus 1 and whose normal operation is checked is transmitted to the slave apparatus 2, the operation error of the slave apparatus 2 due to the operation failure of the FW can be prevented.

Since the FW image is transmitted upon updating the FW in the master apparatus 1, reversible updating such as updating to an older FW is allowed, thereby flexibly updating the FW.

### [Practical Example of Data Processing System]

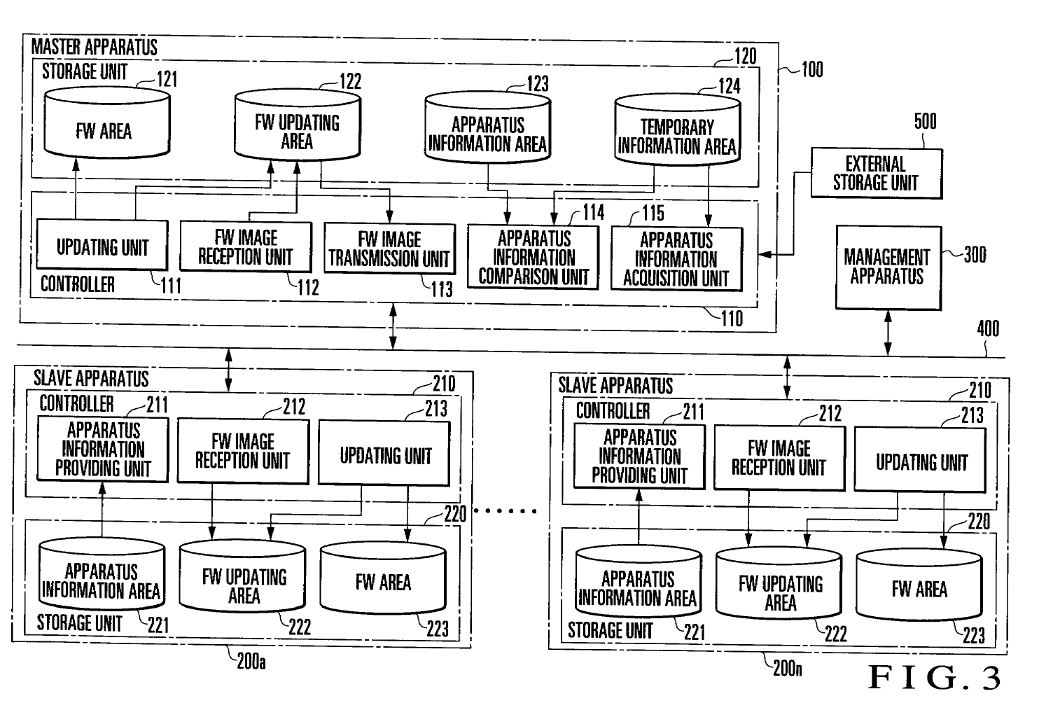

A practical example of the data processing system according to this embodiment will be described below. A data processing system shown in FIG. 3 comprises a master apparatus 100, slave apparatuses 200a to 200n, and a management apparatus 300. These apparatuses are connected to each other via a communication line 400 such as a bus.

### <Master Apparatus>

The master apparatus 100 comprises at least a controller 110 which controls the operation of the master apparatus 100 and a storage unit 120 which stores various kinds of information necessary to implement the operation of the master apparatus 100.

The controller 110 comprises at least an updating unit 111, an FW image reception unit 112, an FW image transmission unit 113, an apparatus information comparison unit 114, and an apparatus information acquisition unit 115.

The updating unit 111 rewrites an FW image stored in the storage unit 120 to the primary area of the storage unit 120, thereby updating the FW in the master apparatus 100.

The FW image reception unit 112 stores the FW image received via the communication line 400 in the storage unit 120.

On the basis of an instruction from the apparatus information comparison unit 114, the FW image transmission unit 113 transmits the FW image stored in the storage unit 120 to the slave apparatuses 200a to 200n via the communication line 400.

The apparatus information comparison unit 114 compares the self apparatus information of the master apparatus 100 with the self apparatus information of the slave apparatuses 200a to 200n to determine whether the FW image is transmitted to the slave apparatuses 200a to 200n.

The apparatus information acquisition unit 115 acquires the self apparatus information from the slave apparatuses 200a to 200n.

The storage unit 120 has an FW area 121, an FW updating area 122, an apparatus information area 123, and a temporary information area 124. The FW area 121 and the FW updating area 122 form the first data storage unit.

The FW area 121 is an area corresponding to the primary area and stores the FW image. The FW operated upon expanding and executing the FW image on the memory controls the operation of the master apparatus 100.

The FW updating area 122 stores the image of the FW updated in the master apparatus 100.

The apparatus information area 123 stores the self apparatus information representing the attributes such as the manufacturer, product name, and manufacturing number of the master apparatus 100.

The temporary information area 124 stores various kinds of information externally acquired by the apparatus information acquisition unit 115.

The master apparatus 100 described above comprises a computer and programs installed in this computer. The computer comprises an arithmetic unit such as a CPU, a storage unit such as a memory and an HDD (Hard Disk Drive), and an I/F unit which exchanges various kinds of information via a communication line. That is, the hardware apparatus cooperates with software to make the programs control the hardware resources, thereby implementing the controller 110 and the storage unit 120. Note that the above programs can be recorded on a computer-readable recording medium such as a flexible disk, CD-ROM, DVD-ROM, or memory card, or can be provided from the management apparatus 300 or an external apparatus via the communication line 400. The storage medium includes a nonvolatile memory which stores an FW image.

### <Slave Apparatus>

The slave apparatuses 200a to 200n have the same arrangement. For the descriptive convenience, the slave apparatuses 200a to 200n will be referred to as a slave apparatus 200 hereinafter.

The slave apparatus 200 comprises a controller 210 and a storage unit 220.

The controller 210 comprises at least an apparatus information providing unit 211, an FW image reception unit 212, and an updating unit 213.

On the basis of a request from the master apparatus 100, the apparatus information providing unit 211 transmits the self apparatus information stored in the storage unit 220 to the master apparatus 100 via the communication line 400.

The FW image reception unit 212 stores in the storage unit 220 the FW image received from the master apparatus 100.

The updating unit 213 rewrites the FW image stored in the storage unit 220 to the primary area of the storage unit 220, thereby updating the FW of the slave apparatus 200.

The storage unit 220 comprises an apparatus information area 221, an FW updating area 222, and an FW area 223. The FW updating area 222 and the FW area 223 form the second data storage unit.

The apparatus information area 221 stores the self apparatus information representing the attributes such as the manufacturer, product name, and manufacturing number of the slave apparatus 200.

The FW updating area 222 stores the FW image received from the master apparatus 100.

The FW area 223 is an area corresponding to the primary area and stores the FW image. The FW operated upon expanding and executing the FW image on the memory controls the operation of the slave apparatus 200.

The slave apparatus 200 described above comprises a computer and programs installed in this computer. The computer comprises an arithmetic unit such as a CPU, a storage unit such as a memory and an HDD (Hard Disk Drive), and an I/F unit which exchanges various kinds of information via a communication line. That is, the hardware apparatus cooperates with software to make the programs control the hardware resources, thereby implementing the controller 210 and the storage unit 220. Note that the above programs can be recorded on a computer-readable recording medium such as a flexible disk, CD-ROM, DVD-ROM, or memory card, or can be provided from the management apparatus 300 or an external apparatus via the communication line 400. The storage medium includes a nonvolatile memory which stores an FW image.

### <Management Apparatus>

The management apparatus 300 manages the overall operation of the entire data processing system by transmitting the image of the FW that the master apparatus 100 updates.

### <Operation of Data Processing System>

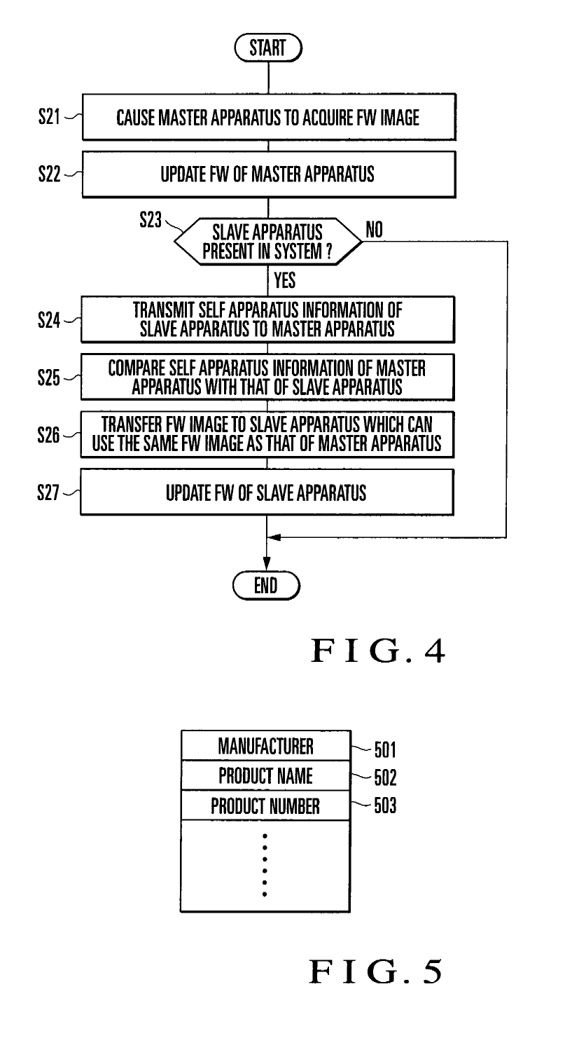

The operation of the data processing system shown in FIG. 3 will be described with reference to FIG. 4.

To update an FW of the data processing system, one of the information processing apparatuses in the data processing system causes the FW image reception unit 112 to acquire the image of the FW subjected to updating from the management apparatus 300 (step S21). The FW is applicable to this information processing apparatus which functions as the master apparatus 100. Upon reception of the FW image, the FW image reception unit 112 of the master apparatus 100 stores the FW image in the FW updating area 122 of the storage unit 120.

Note that the FW image can be acquired not only from the management apparatus 300 but also from an external storage unit such as a USB (Universal Serial Bus) memory, flexible disk, CD-ROM, or DVD-ROM.

Upon acquiring the FW image, the master apparatus 100 causes the updating unit 111 to reboot the master apparatus 100, and the FW image stored in the FW updating area 122 is rewritten to the FW area 121, thereby updating the FW (step S22). At this time, the master apparatus 100 may check the operation of the FW. This makes it possible to expect normal operation of the FW transmitted to the slave apparatus 200 in the following operation.

Upon FW updating, the apparatus information acquisition unit 115 of the master apparatus 100 determines whether an information processing apparatus other than the master 100, i.e., the slave apparatus 200 is present in the data processing system (step S23). This determination can be done by transmitting a signal to other information processing apparatuses via the communication line 400 or inquiring of the management apparatus 300 as to the presence/absence of any other information processing apparatus.

When the slave apparatus 200 is absent in the system (NO in step S23), the master apparatus 100 completes its operation.

On the other hand, if the slave apparatus 200 is present (YES in step S23), the apparatus information acquisition unit 115 of the master apparatus 100 requests transmission of the self apparatus information to the slave apparatus 200. This request is done by sequentially sending the requests to the slave apparatuses 200 or broadcasting the request to all the slave apparatuses 200. When the requests are sequentially sent, the calculation load on the master apparatus 100 can be reduced. However, when the request is broadcast, the FWs of the slave apparatuses 200 included in the data updating system can be immediately updated.

In response to the request from the master apparatus 100, the apparatus information providing unit 211 of the slave apparatus 200 transmits the self apparatus information stored in the apparatus information area 221 of the storage unit 220 to the master apparatus 100 (step S24). Upon reception of the self apparatus information, the apparatus information acquisition unit 115 of the master apparatus 100 stores it in the temporary information area 124 of the storage unit 120.

Upon reception of the self apparatus information from the slave apparatus 200, the apparatus information comparison unit 114 of the master apparatus 100 compares the self apparatus information in the master apparatus 100 with the self apparatus information in the slave apparatus 200 (step S25). More specifically, the apparatus information comparison unit 114 acquires the self apparatus information of the master apparatus 100 from the apparatus information area 123 of the storage unit 120 and the self apparatus information of the slave apparatus 200 from the temporary information area 124 of the storage unit 120 and determines whether they match each other. The self apparatus information contains information such as a manufacturer 501, a product name 502, and a product number 503, as shown in FIG. 5 which can determine whether the FW of the master apparatus 100 is applicable to the slave apparatus 200. When information designated in advance such as at least one of pieces of self apparatus information, specific information, or all pieces of information of the master apparatus 100 matches that of the slave apparatus 100, the apparatus information comparison unit 114 determines that the FW of the master apparatus 100 is applicable to the slave apparatus 200.

When the plurality of slave apparatuses 200 are present, the self apparatus comparison is performed one by one. The comparison order is determined in accordance with the chronological order of the self apparatus information, the order of identification numbers assigned to the slave apparatuses 200, or physical positions of the slave apparatuses 200.

The FW image transmission unit 113 of the master apparatus 100 transmits the FW image stored in the FW updating area 122 to the slave apparatus 200 which is determined by the apparatus information comparison unit 114 and to which the FW of the master apparatus 100 is applicable (step S26). Upon reception of the FW image, the FW image reception unit 212 of the slave apparatus 200 stores the FW image in the FW updating area 222 of the storage unit 220.

Upon reception of the FW image, the updating unit 213 of the slave apparatus 200 performs, e.g., rebooting to rewrite the FW image stored in the FW updating area 222 to the FW area 223 (step S27). The FW is updated in the slave apparatus 200.

As described above, according to this embodiment, when the FW is updated in the master apparatus 100, the image of the updated FW is transmitted to the slave apparatus 200. This makes it possible to eliminate manual updating operation, thus facilitating the updating operation.

Since the FW image is transmitted from the master apparatus 100 to the slave apparatus 200, the master apparatus 100 can control the FW transmission timing and destination. This makes it possible to smoothly transmit the FW.

Since the FW is transmitted based on the result of comparison between the self apparatus information in the master apparatus 100 and the self apparatus information in the slave apparatus 200, it can be determined whether the FW updated in the master apparatus 100 can be applied to the slave apparatus 200. This makes it possible to prevent a case in which the downloaded FW cannot be updated in the slave apparatus 200. Therefore, the slave apparatus 200 can smoothly update the FW.

Since the FW which is updated in the master apparatus 100 and whose normal operation is checked is transmitted to the slave apparatus 200, the operation error of the slave apparatus 200 due to the operation failure of the FW can be prevented.

Since the FW image is transmitted upon updating the FW in the master apparatus 100, reversible updating such as updating to an older FW is allowed, thereby flexibly updating the FW.

This embodiment has exemplified a case in which the FW is updated. However, the data to be updated is not limited to the FW. For example, the present invention is applicable to various kinds of data such as database data and operation programs. Similarly, although this embodiment has exemplified a blade system, it may be equally applicable to a variety of systems if a system has information processing apparatuses subjected to updating of identical data.

According to this embodiment, the master apparatus 100 downloads the updating FW image from the management apparatus 300. However, the management apparatus 300 may transmit the FW image to any one of the information processing apparatuses in the data processing system.

The present invention is applicable to a system (e.g., a blade system) which uploads the same software to a plurality of information processing apparatuses.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A data updating method comprising the steps of:
updating data in a first information processing apparatus by the first information processing apparatus;
acquiring apparatus information of a second information processing apparatus by the first information processing apparatus when the data is updated;
comparing apparatus information of the first information processing apparatus with the acquired apparatus information of the second information processing apparatus by the first information processing apparatus; and
transmitting the updated data to the second information apparatus by the first information processing apparatus on the basis of a comparison result.

2. A method according to claim 1, wherein the step of transmitting comprises the step of transmitting data when the apparatus information of the first information processing apparatus matches the apparatus information of the second information processing apparatus.

3. A method according to claim 1, further comprising the step of causing the second information processing apparatus to update data by storing the data transmitted from the first information processing apparatus.

4. A data processing system comprising a first information processing apparatus and a second information processing apparatus,
said first information processing apparatus comprising:
a first data storage unit which stores data;
an acquisition unit which acquires apparatus information of said second information processing apparatus when data stored in said data storage unit is updated;
a comparison unit which compares apparatus information of said first information processing apparatus with the acquired apparatus information of said second information processing apparatus; and
a transmission unit which transmits the updated data to said second information processing apparatus on the basis of a comparison result in said comparison unit.

5. A system according to claim 4, wherein said transmission unit transmits the data when the apparatus information of said first information processing apparatus matches the apparatus information of said second information processing apparatus.

6. A system according to claim 4, wherein said second information processing apparatus comprises a second data storage unit which updates data by storing the data transmitted from said first information processing apparatus.

7. A data processing system comprising a first information processing apparatus and a second information processing apparatus,
said first information processing apparatus comprising:
first data storage means for storing data;
acquisition means for acquiring apparatus information of said second information processing apparatus when data stored in said data storage means is updated;
comparison means for comparing apparatus information of said first information processing apparatus with the acquired apparatus information of said second information processing apparatus; and
transmission means for transmitting the updated data to said second information processing apparatus on the basis of a comparison result in said comparison means.

8. An information processing apparatus comprising:
a data storage unit which stores data;
an acquisition unit which acquires apparatus information of another information processing apparatus when data stored in said data storage unit is updated;
a comparison unit which compares apparatus information of said information processing apparatus with the acquired apparatus information of the other information processing apparatus; and
a transmission unit which transmits the updated data to the other information processing apparatus on the basis of a comparison result by said comparison unit.

9. A computer-readable recording medium which records a program for causing a computer constituting a first information processing apparatus to execute the steps of:
updating data stored in the first information processing apparatus;
acquiring apparatus information of a second information processing apparatus when the data is updated;
comparing apparatus information of the first information processing apparatus with the acquired apparatus information of the second information processing apparatus; and
transmitting the updated data to the second information processing apparatus on the basis of a comparison result.
